(19) United States
(12) Patent Application Publication
(10) Pub. No.: US 2011/0031704 A1
(43) Pub. Date: Feb. 10, 2011

(54) Segmented Gaskets

(76) Inventors: Brian C. Lehr, Lancaster, PA (US); Derek J. Martin, Leola, PA (US); G. Scott Dossey, Oak Park, IL (US)

Correspondence Address: WOMBLE CARLYLE SANDRIDGE & RICE, PLLC, ATTN: IP DOCKETING, P.O. BOX 7037, ATLANTA, GA, 30357-0037, US

(21) Appl. No.: 12/781,030

(22) Filed: May 17, 2010

Related U.S. Application Data
(60) Provisional application No. 61/216,261, filed on May 15, 2009.
(60) Provisional application No. 61/311,404, filed on Mar. 8, 2010.

(51) Int. Cl. F16J 15/10; B23P 11/00

(52) U.S. Cl. 277/630; 29/428

(57) ABSTRACT

A segmented gasket is formed from two or more gasket segments arranged end-to-end. In one embodiment, the end portions of the gasket segments overlap a predetermined amount to define a region of overlap having a thickness greater than the thickness of the individual gasket segments. An embossed region extends along the gasket segments and aligns in the region of overlap. When compressed between two flanges to be sealed, a continuous seal is formed from one gasket segment, across the region of overlap, and to the other gasket segment. In another embodiment, the gasket segments are locked together with interlocking tabs that project laterally from the end portions of the gasket segments and that are positioned outside of a joint within which the gasket segments are clamped. In a preferred embodiment the gasket segments are metal or rubber coated metal core gasket segments.

### REFERENCE TO RELATED APPLICATIONS

Priority is hereby claimed to the filing dates of U.S. provisional patent application No. 61/216,261 filed 15 May 2009 and U.S. provisional patent application No. 61/311,404 filed 8 Mar. 2010.

### TECHNICAL FIELD

This disclosure relates generally to gaskets and more specifically to segmented gaskets made up of a plurality of gasket segments arranged end-to-end to form a completed gasket.

### BACKGROUND

Segmented gaskets are known wherein a complete gasket for sealing two abutting surfaces is made up of a number of gasket segments that abut each other at their ends to form the gasket. These gaskets may be used for sealing between very large components where it is not feasible to fabricate a single continuous gasket. For example, segmented gaskets may be used to seal the oil pan of a very large industrial engine to the engine block. In many cases, the abutting ends of the individual segments of segmented gaskets are formed with interlocking puzzle-like structures that keep the segments connected and aligned and insure a continuous gasket thickness across the junctions of the segments. Such a configuration works well with thicker gaskets where the interlocking sections connect like puzzle pieces and stay connected. However, for thin gaskets such as metal gaskets and rubber coated metal core gaskets, interlocking end sections is not a viable way to join gasket segments because the gaskets are too thin to maintain an interlock between segments. One prior art solution for thin gaskets has been to form molded rubber ends on metal core gasket segments with the ends being complimentary and with a thickness less than that of the gasket section. In this way, the ends of segments can overlap in a shiplap fashion and the junctions between gasket segments remains more or less the same thickness as the gasket segments. This has not been a completely satisfactory solution, however, at least because each segment of the segmented gasket must be individually fabricated and custom designed for a particular joint. A need exists for a segmented gasket that addresses the shortcomings of the prior art and that provides a thin segmented gasket with sections that are easily and securely joined together to form the completed gasket.

### SUMMARY

U.S. provisional patent application No. 61/216,261 filed 15 May 2009 and U.S. provisional patent application No. 61/311,404 filed 8 Mar. 2010, to both of which priority is claimed, are hereby incorporated by reference in their entireties. Briefly described, a segmented gasket is disclosed wherein a complete gasket is made up of a plurality of gasket segments disposed along and between two mating surfaces to be sealed. The two surfaces may, for instance, be the flanges of an oil pan and the corresponding mating surface of an engine block. In the preferred embodiment, the gasket is a metal or a rubber coated metal core gasket that is thin relative to fiber gaskets and that may have an even thinner rubber coating. The gasket segments preferably are embossed along their lengths to form features that insure that a seal is formed when the gasket is compressed between the surfaces. Each segment of the segmented gasket has an end that, in one embodiment, may simply overlap an end of an adjacent segment with the lines of embossment substantially aligned. The overlapping ends of the gasket segments form a small region where the gasket is double the thickness of or at least thicker than the gasket outside the overlapped regions. It has been found for this embodiment, however, that for metal and rubber coated metal gaskets sealing steel between and cast iron parts, a complete seal can still be formed, especially if a small amount of gasket sealant is disposed at the overlapped regions. In one embodiment, relief slots are formed in the end of each segment at the location where the end of an overlapping segment will lie when the segments are installed to relieve the abrupt change in thickness that otherwise is present at these locations and that might contribute to a leak.

There are circumstances where the thicker portion formed by the overlapping ends of segments is not acceptable. For instance, when sealing between an aluminum oil pan and an aluminum or cast iron engine block, it has been found that the aluminum can be deformed at the junctions of gasket segments when the ends of the segments are overlapped. To address such situations, an alternate embodiment comprises gasket segments having ends that do not overlap but simply abut one another. To align and hold the segments together, the ends are formed with interlocking tabs that project laterally from the segment ends and that are disposed on the inside or the outside of the joint to be sealed. The gasket is assembled by interlocking the tabs together to form the gasket segments into a complete gasket and the assembled gasket is clamped between the mating surfaces to be sealed, with the tabs projecting to one side of the joint.

One advantage of the gasket of the first embodiment is that individual custom gasket segments need not be fabricated. Instead, long lengths of gasket stock can be supplied on rolls and segments can be formed by a user by cutting short sections from the gasket stock prior to installation of the gasket with its ends overlapping. An advantage of the second embodiment is that large gaskets can be formed from gasket segments by interlocking their tabs together and the resulting gasket can be used where overlapped ends are not viable. These and other features, aspects, and advantages of the disclosed gasket will become more apparent upon review of the detailed description set forth below when taken in conjunction with the accompanying drawing figures, which are briefly described as follows.

### BRIEF DESCRIPTION OF THE DRAWINGS

FIG. 1 is a perspective view of a portion of a gasket segment used to form the segmented gasket according to one embodiment of the disclosure.

FIG. 2 is an enlarged view of the end portion of the gasket segment of FIG. 1.

FIG. 3 is a perspective view showing two overlapping gasket segments according to the one embodiment disposed on a surface to be sealed, in this case an oil pan.

FIG. 4 is a perspective view showing the overlapping ends of two gasket segments according to the first embodiment of the disclosure.

FIG. 5 is a CAD image showing the results of a finite element pressure analysis performed on gasket segments with overlapping ends wherein dark blues indicating lower pressures and greens, yellows, and reds indicating higher pressures under operational conditions.

FIG. 6 is a perspective view illustrating an alternate form of the first embodiment of the gasket with relief slots formed in the ends of the segments to reduce abrupt thickness changes.

FIG. 7 is a plan view of a second embodiment of the gasket of this invention wherein ends of gasket segments within the joint are not overlapped, but segments are locked together with extra-joint interlocking tabs.

FIG. 8 is a perspective view illustrating the attachment of the extra-joint interlocking tabs of the second embodiment to secure segments of a gasket together.

### DETAILED DESCRIPTION

Referring now in more detail to the drawing figures, wherein like reference numerals designate like parts throughout the several views, FIG. 1 illustrates an elongated gasket segment 11 according to a first embodiment of the disclosure. In the illustrated embodiment, the gasket section 11 is made of a thin strip of metal and thus may be referred to as a metal gasket. Alternatively, the metal may be coated with a rubber coating, in which case the gasket may be referred to as a rubber coated metal core gasket. The features disclosed herein refer to either or both configurations. The gasket segment 11 has an upper surface 12, a lower surface 13, an end portion 16, and spaced bolt holes 14 positioned to align with bolts when the gasket segment is compressed between surfaces to be sealed. An embossed portion 17 of the gasket segment extends along an interior edge portion of the segment and, in this embodiment, is configured as a small crimp or step. In use, the embossed portion 17 results in a line of higher pressure between sealed flanges and thus insures that a complete seal is formed.

The thickness of the gasket segment has been exaggerated in the drawings for clarity of description. In reality, the segment may have a thickness between about 0.008 and 0.010 inch. If a rubber coating is applied to form a rubber coated metal core gasket, the rubber coating typically may have a thickness from about 0.001 to 0.010 inch. These thicknesses are given as exemplary only, however, and thicknesses outside these ranges may well be used by skilled artisans without departing from the scope of this disclosure.

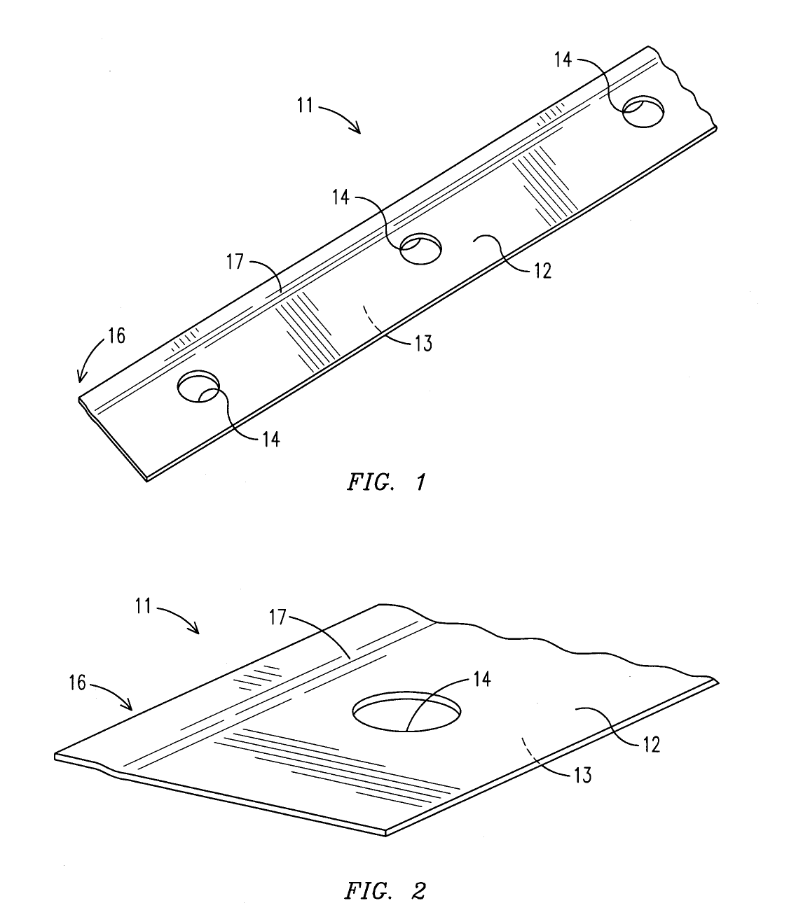

FIG. 2 is an enlarged illustration of the end portion 16 of the gasket segment 11 shown in FIG. 1. The embossed portion 17 is better illustrated in FIG. 2 and is seen to comprise a small step embossed into the gasket segment. It will be understood that other configurations of the embossed portion 17 are possible such as, for instance, an embossed bead or multiple embossed beads. Any and all such configurations are encompassed within the scope of this disclosure and the configuration illustrated in the figures is understood to represent only one exemplary configuration.

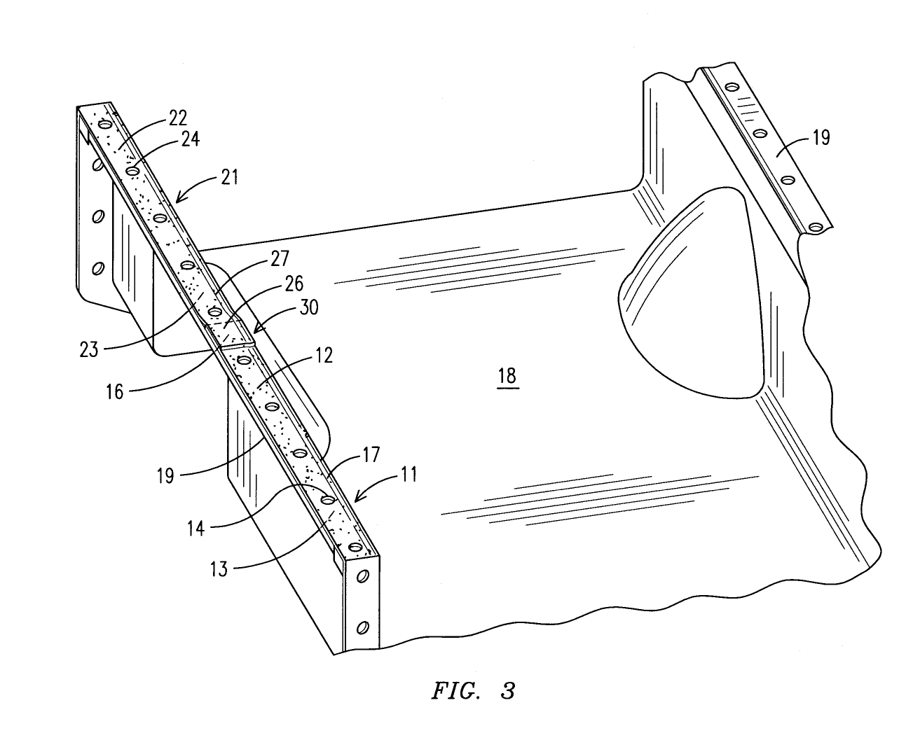

FIG. 3 illustrates two gasket segments 11 and 21 disposed along a flange 19 of a component, in this case an oil pan 18, for sealing between the oil pan and an engine block when the oil pan is installed. For this embodiment, the oil pan preferably is made of steel and not aluminum for reasons that will become more clear below. Gasket segment 21 is identical in its details to gasket segment 11, which is described in detail above. Generally, gasket segment 21 has an upper surface 22, a lower surface 23, bolt holes 24, an end portion 26, and a line of embossment or embossed portion 27. As illustrated by the phantom outline of gasket segment 11, the end portion 16 of gasket segment 11 extends beneath the end portion 26 of gasket segment 21 a predetermined distance. In other words, the end portion of gasket segment 21 can be said to overlap the end portion 16 of gasket segment 11 to define a region of overlap, generally identified with reference numeral 30 in FIG. 3. Contrary to conventional wisdom, the thickness of the complete gasket is not maintained throughout its extent. Instead, a double or at least increased thickness of gasket material is present in regions of overlap 30 between gasket segments. Surprisingly, however, for thin metal and rubber coated metal core gaskets, it has been discovered by the inventors that a complete seal can still be achieved with no leakage at the overlapping junctions of the gasket segments, as detailed below.

It will be understood that while FIG. 3 illustrates only two gasket segments with overlapping ends, in reality numerous gasket segments might be used to form a complete gasket along the flange of a component such as an oil pan. The oil pan itself may be segmented in that it may be formed by bolting two or more oil pan segments together to form the completed oil pan. In large components, such as oil pans for heavy mining equipment, the component can be large such as on the order of several feet, requiring numerous gasket segments to form a completed gasket along its flanges.

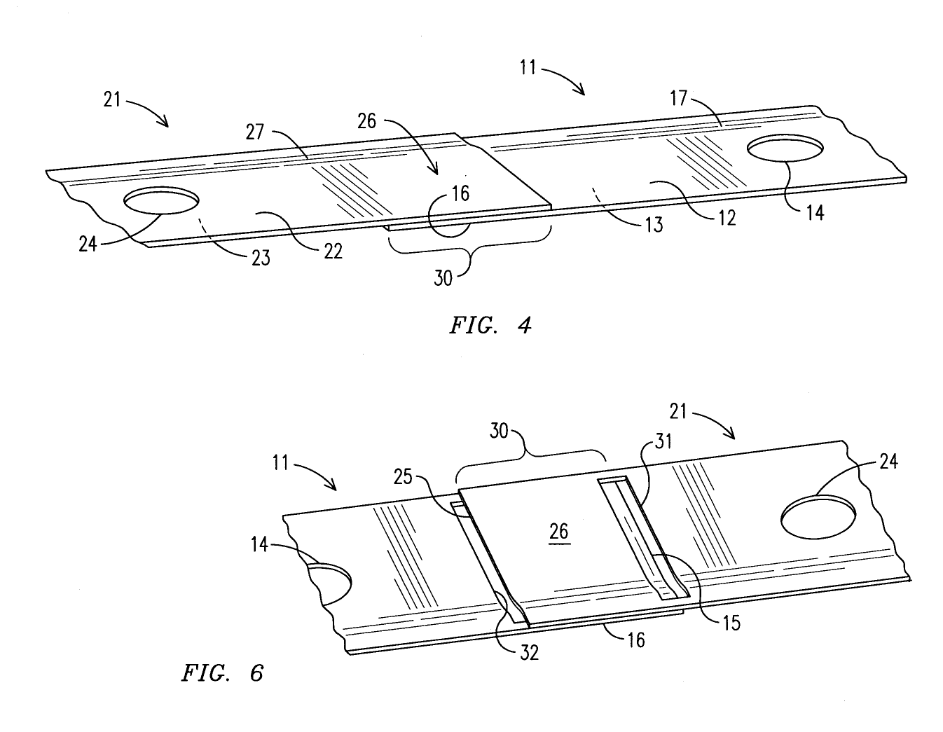

FIG. 4 illustrates better the region of overlap 30 between gasket segment 11 and gasket segment 21. Again in this figure, the thicknesses of the gasket segments have been exaggerated for clarity of description. When overlapped as shown in FIG. 4, the inside and outside edges of the gasket segments align with each other and, perhaps more importantly, the embossed features extending along the inside edge portion of the gasket segments align with and overlap one another. This helps to form a continuous seal across the region of overlap when the gasket is compressed between a pair of flanges to be sealed. The length of the region of overlap 30 can vary widely depending upon application specific requirements and constraints. For example, the overlap might be as short as a few millimeters or as long as a few centimeters. The scope of the present disclosure is intended to encompass a region of overlap of any length. Is has been found, however, that an overlap between about 10 and about 30 millimeters, and more specifically 25 millimeters functions well and thus is a preferred embodiment.

FIG. 5 shows the results of a finite element pressure analysis modeled on a computer for the gasket configuration shown in FIG. 3. The simulation modeled the pressure that would be experienced along the length and across the width of the gasket, and particularly in and around the region of overlap 30, were the gasket to be compressed between the flanges of the oil pan and the mating flanges of an engine block. Lowest pressures resulting from the simulation are indicated in dark grey in FIG. 5, while highest pressures are indicated in light grey. Intermediate pressures are indicated by intermediate shades of gray. As can be seen from this analysis, high pressures are generated in the regions of the bolts, as would be expected. Further, high pressures are experienced in the region of overlap 30, which also is expected because of the increased thickness of gasket material in this region. Interestingly, the highest pressures are experienced at the ends of the region of overlap 30 where the ends of the two gasket segments are located. Pressures in the central portion of the region of overlap are significantly lower, as indicated by the dark gray in these portions. However, continuous high pressure is generated along the inside edge portion of the region of overlap 30 as indicated by the light gray shades across this region. This is due to the overlapping embossed sections in this area. It would thus be expected that a complete seal will be formed along the length of the region of overlap 30.

With continuing reference to FIG. 5, it will be seen that an intermediate shade of gray line extends along the inside edge portion of the gasket along the embossed feature. This indicates a continuous line of relatively high pressure created when the embossed feature or pattern is compressed between the flanges and, in fact, is a primary contributor to the formation of a seal by the gasket. It also will be seen in FIG. 5 that there is a short gap between the intermediate gray line and either side of the region of overlap 30. This indicates a short section where generated pressures may not be high enough to form a reliable seal at the sides of regions of overlap. It has been discovered, however, that the application of a small bit of gasket sealant such as RTV sealant on either side of the regions of overlap successfully addresses the small low pressure areas and forms a reliable continuous seal along the length of the gasket.

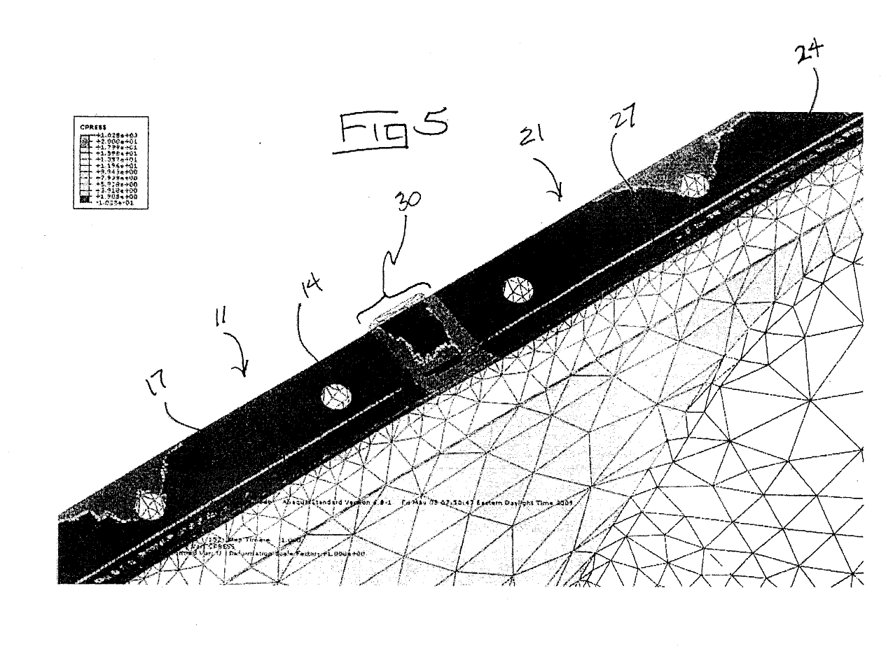

FIG. 6 illustrates an alternative configuration of the segmented gasket of this embodiment. Again, thicknesses are exaggerated for clarity. The gasket is formed of a plurality of gasket segments 11 and 21 disposed along a flange to be sealed with their end portions 16 and 26 overlapping as described above to form a region of overlap 30. In this embodiment, however, a relief slot 31 is formed in the end portion of gasket segment 21 positioned to align with the end 15 of underlying gasket segment 11. Similarly, a relief slot 32 is formed in the end portion of gasket segment 11 positioned to align with the end 25 of overlying gasket segment 21. When a gasket of this embodiment is compressed between a pair of flanges to be sealed, the ends 15 and 25 are pressed at least partially into corresponding relief slots 31 and 32. This relieves the abrupt pressure increase at the ends of the gasket segments shown in FIG. 5 and results instead in a more gradual pressure transition and a more uniform pressure profile across the region of overlap 30. Further, during installation of the gasket, the relief slots provide a visual indication as to where an installer should put a small bit of gasket sealant to insure a continuous seal from one segment, across the region of overlap, to the adjacent segment.

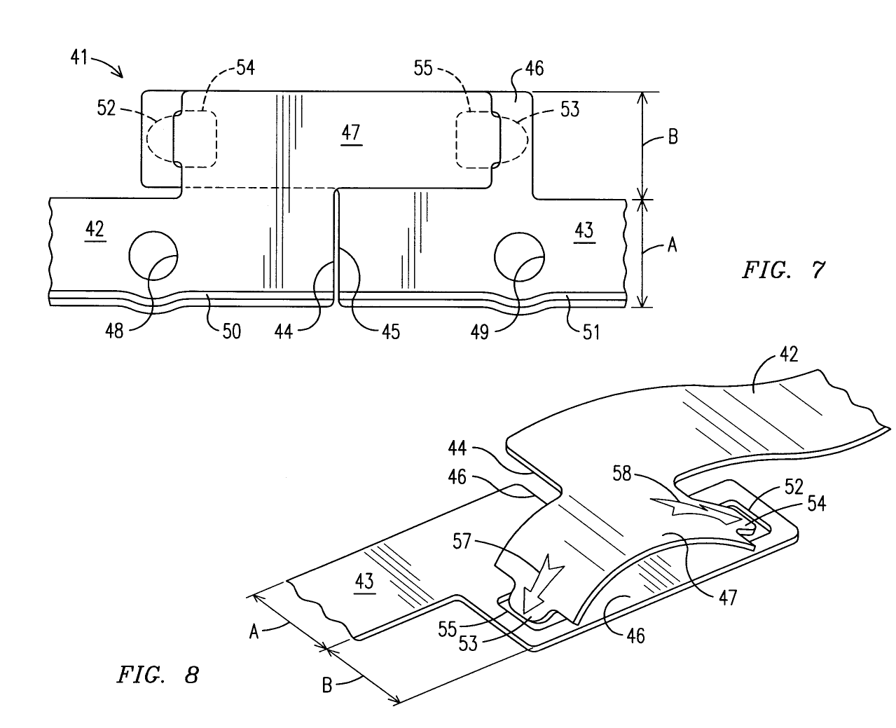

FIGS. 7 and 8 illustrate a second embodiment of a segmented gasket according to the invention. This embodiment is configured for use to seal a joint between mating surfaces in situations where overlapping gasket segment ends within the joint are unacceptable, such as when one of the surfaces is made of a softer metal such as aluminum. For such situations, it has been found that the increased thickness in regions of overlap when using the first embodiment can cause the softer aluminum to deform where the segments overlap, resulting in leak potential. As a specific example, this embodiment functions well when sealing an aluminum oil pan to an engine block wherein overlapping gasket segment ends can cause the aluminum to deform under pressure. Referring to FIG. 7, a junction 41 between two gasket segments 42 and 43 is illustrated. The gasket segment 42 has an end 44, bolt holes 48 (only one being visible) and an embossed feature 50. Similarly, gasket segment 43 has an end 45, bolt holes 49 and an embossed feature 51. The gasket segments 42 and 43 are sized to fit in the joint between two mating surfaces within region A and thus may be said to be intra-joint.

A female tab 46 is formed with and projects laterally from the gasket segment 43. The female tab 46 is formed with slots 54 and 55 adjacent its end portions. A male tab 47 is formed with and projects laterally from the gasket segment 42. The male tab is formed with a pair of projecting tongues 52 and 53. The male tab is sized and configured to overlie the female tab 46 when the gasket segments are brought together with their ends 44 and 45 abutting but not overlapped with one another. Further, the tongues 52 and 53 of the male tab are seen to extend into the slots 54 and 55 respectively so that the ends of the tongues reside beneath or within the female tab 46. In this configuration, the male tab 47 and female tab 46 embrace one another and are locked securely together, which, in turn, securely locks gasket segments 42 and 43 together with their ends 44 and 45 abutting but not overlapping. Further, the male and female tabs are located in region B, which is outside of the joint between the mating surfaces. The tabs may thus be referred to as being extra-joint. In this way, the overlapping portions of the gasket segments, i.e. the male and female tabs, reside outside of the joint and within the joint there are no overlapping portions that result in increased thicknesses. A plurality of gasket segments may be attached and locked together in this manner to form a completed gasket, which can then be clamped between mating surfaces to form a seal. The male and female tabs may reside outside the sealed joint or inside the sealed joint as desired. If outside the sealed joint, they may be snapped off once the gasket is securely clamped between the mating surfaces if necessary. For this purpose, the gasket segments may be formed with a score between the gasket segments and their tabs to facilitate a clean break. If inside the sealed joint, the gasket should be configured so that the inwardly projecting tabs do not interfere with the flow of liquid, such as oil in the case of an oil pan, within the structures being sealed.

FIG. 8 illustrates a preferred method of locking the male and female tabs together, which may be done by a mechanic or other installer prior to clamping the finished gasket between mating surfaces. Since, in the preferred embodiment, the gasket segments are thin metal or thin rubber coated metal core gaskets; the male and female tabs 47 and 46 are relatively ridged but nevertheless flexible or springy. Thus, to lock the tabs and therefore the gasket segments together, a mechanic need only pinch the male tab between his or her thumb and forefinger to bend it into an arched configuration as illustrated in FIG. 8 until the tongues 52 and 53 are positioned inside the outermost edges of slots 54 and 55 respectively. The male tab 47 can then be released, whereupon the male tab springs back toward its flat configuration. In the process, the tongues 52 and 53 snap into respective slots 54 and 55 as indicated by arrows 57 and 58 in FIG. 8. In this way, the tabs and consequentially the gasket segments are securely locked together. It has been found that a completed gasket formed of segments locked together by their respective tabs maintains its shape well and can be handled easily to place it between surfaces to be sealed, just as if the gasket were made as a single unitary component.

The invention has been described herein in terms of preferred embodiments and methodologies considered by the inventor to represent the best mode of carrying out the invention. It will be understood, however, that those of skill in the art may make a wide variety of additions, deletions, and modifications to the embodiments illustrated herein without departing from the spirit and scope of the invention. For example, while the invention is illustrated within the context of metal and/or rubber coated metal gaskets, it will be understood that it might also be employed with gaskets made of other materials such as fibrous gasket material. The application of an embossed feature is preferred; however, it may not be required for all applications. The particular placement and configuration of the tongues and slots in the second embodiment shown in FIGS. 7 and 8 have been found to work well, but other placements and configurations may be possible and are included within the scope of the invention. Indeed, the extra-joint tabs may be secured together by a completely different mechanism such as, for instance, with a mechanical fastener, adhesive, longitudinal sliding slots and tabs, or otherwise. Other modifications and additions, both subtle and gross, might well be made by skilled artisans within the scope of the invention, which is delineated only by the claims.

What is claimed is:

1. A gasket comprising a first gasket segment having a first extra-joint tab and a second gasket segment having a second extra-joint tab, the first and second extra-joint tabs being configured to be coupled together to join the first gasket segment to the second gasket segment.

2. The gasket of claim 1 and wherein the first extra-joint tab is formed with at least one tongue and the second extra-joint tab is formed with at least one slot sized and positioned to receive the tongue to couple the extra-joint tabs together.

3. The gasket of claim 1 and wherein the extra-joint tabs are positioned to be disposed outside of a joint when the gasket is clamped within the joint.

4. The gasket of claim 1 and wherein the first extra-joint tab comprises a female tab with slots and the second extra-joint tab comprises a male tab with tongues, the tongues of the male tab extending into the slots of the female tab to lock the tabs together.

5. The gasket of claim 4 and wherein the male tab is flexible and wherein its tongues are configured to align with the slots of a juxtaposed female tab when the male tab is flexed into an arch, release of the male tab urging the tongues into the slots to interlock the tabs together.

6. The gasket of claim 1 and wherein the gasket segments are made of metal.

7. The gasket of claim 1 and wherein the gasket segments comprise a metal core and a coating.

8. The gasket of claim 7 and wherein the coating is a rubberized material.

9. The gasket of claim 8 and wherein the coating is rubber.

10. A gasket comprising a plurality of gasket segments having ends and being arranged end-to-end, at least some of the gasket segments having tabs projecting laterally from their ends so that the tabs are located outside of a joint to be sealed when the gasket is disposed in the joint, the tabs being attached together to secure the gasket segments to one another.

11. A gasket as claimed in claim 10 and wherein the tab of one gasket segment at least partially overlies the tab of an adjacent gasket segment.

12. A gasket as claimed in claim 11 and wherein overlying tabs are mechanically interlocked together.

13. A gasket as claimed in claim 12 and wherein one of the overlying tabs comprises a male tab with at least one tongue and the other one of the overlying tabs comprises a female tab with at least one slot, the at least one tongue being disposed within the at least one slot to interlock the tabs together.

14. A gasket as claimed in claim 13 and wherein the at least one tongue comprises a pair of tongues and the at least one slot comprises a pair of slots.

15. A gasket as claimed in claim 14 and wherein the male tab is sufficiently flexible to be flexed into an arch to align its tongues with the slots of the female tab, release of the male tab urging its tongues into the slots of the female tab.

16. A gasket as claimed in claim 10 and wherein the gasket segments are made of metal.

17. A gasket as claimed in claim 10 and wherein the gasket segments comprise a metal core having a non-metal coating.

18. A gasket as claimed in claim 17 and wherein the non-metal coating comprises a rubberized coating.

19. A gasket as claimed in claim 17 and wherein the non-metal coating comprises rubber.

20. A method of attaching gasket segments together end-to-end comprising the steps of:
(a) obtaining at least two gasket segments having ends and tabs projecting laterally from the gasket segments adjacent their ends;
(b) bringing the ends of the gasket segments together; and
(c) securing the tab of one gasket segment to the tab of another gasket segment to attach the gasket segments together.

21. The method of claim 20 and wherein step (b) comprises bringing the ends together such that they do not overlap.

22. The method of claim 20 and wherein the tabs are positioned to overlap at least partially in step (b) and wherein step (c) comprises mechanically interlocking the tabs of the gasket segments together.

23. The method of claim 22 and wherein the step of mechanically interlocking comprises inserting at least one tongue of one of the tabs into at least one slot of the other one of the tabs.
